(19) United States
(12) Patent Application Publication
(10) Pub. No.: US 2026/0080119 A1
(43) Pub. Date: Mar. 19, 2026

(54) METHOD AND DEVICE FOR PREDICTING LONG-TERM CREEP DATA BASED ON SHORT-TERM CREEP DATA

(71) Applicant: Tianjin University, Tianjin (CN)

(72) Inventors: Lianyong Xu, Tianjin (CN); Lei Zhao, Tianjin (CN); Chengchong Hu, Tianjin (CN); Yongdian Han, Tianjin (CN); Kangda Hao, Tianjin (CN)

(73) Assignee: Tianjin University, Tianjin (CN)

(21) Appl. No.: 19/286,160

(22) Filed: Jul. 30, 2025

(30) Foreign Application Priority Data
Sep. 18, 2024 (CN) 202411299955.1

(51) Int. Cl. G06F 30/20; G06F 30/13; G06F 119/04; G06F 119/14

(52) U.S. Cl. CPC G06F 30/20; G06F 2119/04; G06F 2119/14

(57) ABSTRACT

A method and device for predicting long-term creep data based on short-term creep data. The method comprises: obtaining steady-state creep rate data of a material under different stress levels through a step-loading method for multi-stage stress based on short-term creep data; determining first fitting parameter values of a creep deformation performance model through nonlinear fitting; determining the creep stress exponents under different stress levels based on the steady-state creep rate data and creep stress; determining the creep damage parameters under different stress levels based on the creep stress exponents and a creep damage parameter model; determining the second fitting parameter values of a creep deformation prediction model through nonlinear fitting to predict the long-term creep deformation of the material; and determining the third fitting parameter values of a creep life prediction model based on the second fitting parameter values to predict the long-term creep life of the material.

### CROSS-REFERENCE TO RELATED APPLICATION

This application claims the priority benefit of Chinese patent application No. 202411299955.1, filed on Sep. 18, 2024. The entirety of the above-mentioned patent application is hereby incorporated by reference herein and made a part of this specification.

### BACKGROUND

### Technical Field

This disclosure belongs to the technical field of creep prediction, and more specifically, relates to a method and device for predicting long-term creep data based on short-term creep data.

### Description of Related Art

With the development of modern industry, energy demand is growing increasingly. To improve thermal efficiency and reduce resource consumption, modern energy equipment continues to evolve towards high temperature and high pressure, which imposes higher requirements on equipment safety and reliability. Under high temperature and high-pressure conditions, creep is the predominant form of structural failure under high-temperature. Creep refers to the phenomenon in which solid materials exhibit continuously increasing strain over time under constant stress conditions.

The creep problem under high-pressure conditions has been relatively well solved, but the creep deformation and damage at high temperatures have not yet been effectively addressed. High-temperature creep is a complex time-dependent phenomenon. Using creep data obtained from relatively short-term tests (testing time<10,000 hours) to predict long-term (>100,000 hours) creep behavior is critically importance for the design and evaluation of high-temperature structures.

Currently commonly used creep life prediction methods include the isothermal line method, rate equation-based parameter method, and empirical parameter method. The isothermal line method assumes that logarithmic life varies linearly with logarithmic stress, but such extrapolation in long-term creep life tends to produce dangerously overestimated results. The rate equation-based parameter method hypothesizes that creep is controlled by rate processes. However, experiments show that rate processes fail as stress decreases, limiting the extrapolation capability of this method. The empirical parameter method typically employs complex functions to determine the relationship between creep life and temperature/stress through nonlinear fitting. Nevertheless, this method requires substantial experimental data, and its reliability during extrapolation remains unverified. Therefore, there is an urgent need to develop a method for predicting long-term creep deformation and lifetime based on short-term creep data, enabling rapid and accurate evaluation of materials' long-term creep performance.

### SUMMARY

To address the deficiencies in existing technologies, embodiments of the present disclosure provide a method and device for predicting long-term creep data based on short-term creep data, aiming to solve the problems of low extrapolation accuracy or dependence on long-term creep test results in prior art.

In a first aspect, embodiments of the present disclosure provide a method for predicting long-term creep data based on short-term creep data, comprising:
conducting short-term creep tests using a step-loading method under multi-stage stress to obtain steady-state creep rate data of the material at different stress levels;
determining first fitting parameter values of a creep deformation performance model through nonlinear fitting; wherein the creep deformation performance model is used to characterize the evolution law of the material's steady-state creep rate with stress;
determining the creep stress exponent n at different stress levels based on steady-state creep rate data and creep stress;
determining the creep damage parameter β_{D} at different stress levels based on the creep stress exponent n and a creep damage parameter model; wherein the creep damage parameter model characterizes the evolution law of the material's creep damage parameter β_{D} and creep stress exponent n;
determining second fitting parameter values of a creep deformation prediction model through nonlinear fitting based on short-term creep test data, the creep deformation performance model, and the creep damage parameter; and predicting long-term creep deformation of the material using the creep deformation prediction model;
determining third fitting parameter values of a creep life prediction model based on the second fitting parameter values; and predicting long-term creep life of the material using the creep life prediction model, the steady-state creep rate and the creep damage parameter.

In a second aspect, embodiments of the present disclosure further provide a device for predicting long-term creep data based on short-term creep data, the device comprising:
an acquisition module, configured to perform short-term creep tests using a multi-stage stress loading method, and to acquire steady-state creep rate data of the material under different stress levels;
a first determination module, configured to determine first fitting parameter values of a creep deformation performance model through nonlinear fitting; the creep deformation performance model being used to characterize the evolution law of the material's steady-state creep rate with stress;
a second determination module, configured to determine a creep stress exponent n at different stress levels based on the steady-state creep rate data and creep stress;
a third determination module, configured to determine a creep damage parameter β_{D} at different stress levels based on the creep stress exponent n and a creep damage parameter model; the creep damage parameter model being used to characterize the evolution law of the material's creep damage parameter with the creep stress exponent;
a first prediction module, configured to determine second fitting parameter values of a creep deformation prediction model through nonlinear fitting based on the short-term creep test data, the creep deformation performance model and the creep damage parameter β_{D}, and predict long-term creep deformation of the material using the creep deformation prediction model;
a second prediction module, configured to determine third fitting parameter values of a creep life prediction model based on the second fitting parameter values, and predict long-term creep life of the material using the creep life prediction model, steady-state creep rate and creep damage parameter.

By predicting the long-term creep life of materials, the prediction results of long-term creep life can be applied to the safety evaluation and full life cycle management of high-temperature steam pipeline equipment. Specifically, by comparing the predicted long-term creep life with the actual accumulated operating time of the high-temperature steam pipeline, the remaining service life can be quantified. A life status classification report (Safe/Warning/Critical) is then generated to serve as a core reference for operational decision-making. When the remaining life approaches or falls below the preset safety design threshold (critical value), targeted maintenance strategies for the high-temperature steam pipeline are formulated and triggered. Planned shutdown inspections are initiated for high-risk pipe sections, adopt portable ultrasonic thickness gauge and field metallographic microscope to detect creep damage on high-risk pipe sections, positioning and marking life exhausted pipe sections and drive automate cutting robots with all-position automate welding machines to perform replacement procedures. Alternatively, pulsed argon arc welding be used to attach reinforcement rings, or carbon fiber composite materials be wrapped around locally over-damaged sections for structural reinforcement. Based on the model, the safety stress threshold range of the high-temperature steam pipeline is back-calculated to guide power plant operators in optimizing operational parameters. A pressure reduction operation protocol is triggered when the remaining service life approaches the critical threshold. The boiler combustion controller is linked to reduce the system load by 10%, thereby extending the pipeline's service life and ensuring operation within a safe margin. Ultimately, a closed-loop control framework is established, comprising the stages of life prediction, status classification, proactive maintenance, operational optimization, and safety assurance. This closed-loop control framework provides accurate full life cycle management for high-temperature steam pipelines.

In a second aspect, embodiments of the present disclosure further provide a device for predicting long-term creep data based on short-term creep data, comprising:
an acquisition module, configured to perform short-term creep tests using a step-loading method under multi-stage stress and acquire steady-state creep rate data of the material at different stress levels;
a first determination module, configured to determine first fitting parameter values of a creep deformation performance model through nonlinear fitting; the creep deformation performance model being used to characterize the evolution law of the material's steady-state creep rate with stress;
a second determination module, configured to determine a creep stress exponent n at different stress levels based on the steady-state creep rate data and creep stress;
a third determination module, configured to determine a creep damage parameter β_{D} at different stress levels based on the creep stress exponent n and a creep damage parameter model; the creep damage parameter model being used to characterize the evolution law of the material's creep damage parameter with the creep stress exponent β_{D};
a first prediction module, configured to determine second fitting parameter values of a creep deformation prediction model through nonlinear fitting based on the short-term creep test data, the creep deformation performance model and the creep damage parameter β_{D}, and predict long-term creep deformation of the material using the creep deformation prediction model;
a second prediction module, configured to determine third fitting parameter values of a creep life prediction model based on the second fitting parameter values, and predict long-term creep life of the material using the creep life prediction model, steady-state creep rate and creep damage parameter β_{D}.

In a third aspect, embodiments of the present disclosure further provide an electronic device, comprising: at least one memory configured to store programs; at least one processor configured to execute the programs stored in the memory, wherein when the programs stored in the memory are executed, the processor is configured to perform the method described in the first aspect or any possible implementation of the first aspect.

In a fourth aspect, embodiments of the present disclosure further provide a computer-readable storage medium storing computer programs which, when executed by a processor, cause the processor to perform the method described in the first aspect or any possible implementation of the first aspect.

In a fifth aspect, embodiments of the present disclosure further provide a computer program product which, when executed by a processor, causes the processor to perform the method described in the first aspect or any possible implementation of the first aspect.

The long-term creep data prediction method and device based on short-term creep data provided in the embodiments of this disclosure adopt a multi-stage stress loading method that considers the transition of creep damage evolution mechanisms between short-term and long-term creep conditions. This method can accurately characterize the accelerated creep damage effects under prolonged service conditions. The prediction of long-term creep deformation and service life requires only short-term creep test data without relying on actual long-term creep test results of materials. The solution demonstrates excellent capability in predicting long-term creep deformation and life data under low stress conditions, with high extrapolation accuracy and reliable prediction precision, while significantly reducing testing time and costs compared to conventional methods.

### BRIEF DESCRIPTION OF THE DRAWINGS

To clearly illustrate the technical solutions in this disclosure or related technologies, the following provide a brief description of the drawings necessary for describing the embodiments or related technologies. Obviously, the following drawings describe some embodiments of this disclosure. For those people skilled in the art, other drawings may be obtained based on these drawings without creative effort.

FIG. 1 is a schematic flowchart of a method for predicting long-term creep data based on short-term creep data according to an embodiment of the present disclosure.

FIG. 2 is a schematic diagram of multi-stage stress loading according to embodiments of the present disclosure.

FIG. 3 is a schematic diagram of parameter fitting for a creep deformation performance model according to embodiments of the present disclosure.

FIG. 4 is a schematic diagram of parameter fitting for a creep deformation prediction model according to embodiments of the present disclosure.

FIG. 5 is a schematic diagram of results of long-term creep deformation prediction according to embodiments of the present disclosure.

FIG. 6 is a schematic diagram of results of long-term creep life prediction according to embodiments of the present disclosure.

FIG. 7 is a schematic structural diagram of a device for predicting long-term creep data based on short-term creep data according to embodiments of the present disclosure.

FIG. 8 is a schematic structural diagram of an electronic device according to embodiments of the present disclosure.

### DETAILED DESCRIPTIONS OF THE EMBODIMENTS

In order for the objectives, technical solutions, and advantages of the disclosure to be more comprehensible, the disclosure is further described in detail below in conjunction with the embodiments accompanied with drawings. It should be understood that the specific embodiments described herein are only used to describe the disclosure and are not used to limit the disclosure.

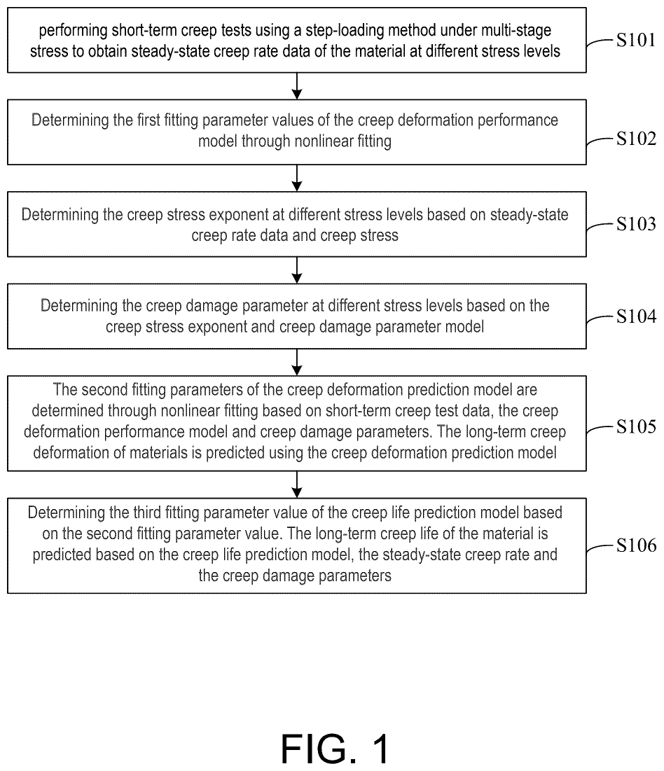

FIG. 1 is a schematic flowchart of a method for predicting long-term creep data based on short-term creep data according to an embodiment of the present disclosure. As shown in FIG. 1, the method includes at least the following steps:

S101: performing short-term creep tests using a step-loading method under multi-stage stress to obtain steady-state creep rate data of the material at different stress levels:
specifically, the creep rate refers to the ratio of creep deformation to time within a certain period, i.e., the amount of creep deformation per unit time, and the steady-state creep rate refers to the amount of creep deformation per unit time when the creep rate reaches a relatively stable state (i.e., when the creep rate no longer changes significantly with time) during the creep process.

The short-term creep tests are performed using the step-loading method under multi-stage stress to obtain steady-state creep rate data of the material at different stress levels, or in other words, across a wide stress range.

In some embodiments, the step-loading method for multi-stage stress in S101 specifically comprises the following steps:
considering the transition of the evolution law of creep damage between short-term and long-term creep conditions, and to accurately characterize the accelerated creep damage effect under long-term creep conditions, the stress is applied sequentially from smallest to largest. The creep test at each stress level continues until reaching the steady-state creep stage before proceeding to the next stress level, thereby obtaining steady-state creep rate data of the material under different stress levels. The steady-state creep stage refers to a uniform creep deformation at a relatively slow rate under constant stress and temperature.

In some embodiments, all graded stress levels exceed 10% σ_{y}, where σ_{y} represents the material's yield strength.

S102: determining the first fitting parameter values of the creep deformation performance model through nonlinear fitting:
specifically, perform nonlinear fitting on the steady-state creep rate data of the material obtained in S101 under different stress levels to determine the first fitting parameter values of the creep deformation performance model.

The creep deformation performance model, also called the steady-state creep rate constitutive equation, is used to characterize the evolution law of the steady-state creep rate of the material with stress. By performing nonlinear fitting on the steady-state creep rate data of the material under different stress levels, the first fitting parameter values of the creep deformation performance model are determined. The first fitting parameter values include the creep stress exponents n₁ and n₂, and the creep stress coefficients A₁ and A₂.

In some embodiments, the creep deformation performance model specifically satisfies the following calculation formula:

$${\dot{ε}}_{c , s} = {A}_{1} {σ}^{{n}_{1}} + {A}_{2} {σ}^{{n}_{2}} ,$$

where: \dot{ε}_{c,s} is the steady-state creep rate, n₁ and n₂ are the fitted creep stress exponents, A₁ and A₂ are the fitted creep stress coefficient, σ is the creep stress.

S103: determining the creep stress exponent n at different stress levels based on steady-state creep rate data and creep stress:
specifically, the creep rate describes the rate of strain variation during the creep process, creep stress refers to the stress causing creep deformation. The creep stress exponent characterizes the relationship between creep stress and creep rate.

In some embodiments, the creep stress exponent n is determined by the following calculation formula:

$$n = \frac{d 1 g ( {\dot{ε}}_{c , s} )}{d 1 g ( σ )} ,$$

where: \dot{ε}_{c,s} represents the steady-state creep rate, σ represents the creep stress.

S104: determining the creep damage parameter at different stress levels based on the creep stress exponent and creep damage parameter model:

specifically: the creep damage parameter model characterizes the evolution of the creep damage parameter β_{D} with respect to the creep stress exponent n. After calculating the creep stress exponent n in S103, the creep damage parameter β_{D} can be derived from the model based on the creep damage parameter model. The creep damage parameter β_{D} describes the influence of creep damage on creep life under different creep mechanisms.

In some embodiments, the creep damage parameter model satisfies the following calculation formula:

$${β}_{D} = 0.3034 exp ( - 0.1023 n ) + 0.5031 exp ( - 0.3519 n ) + 0.1634 exp ( - 0.01213 n ) ,$$

Where, β_{D} is creep damage parameter, n is Creep stress exponent.

S105. The second fitting parameters of the creep deformation prediction model are determined through nonlinear fitting based on short-term creep test data, the creep deformation performance model and creep damage parameters β_{D}. The long-term creep deformation of materials is predicted using the creep deformation prediction model.

Specifically, the second fitting parameters of the creep deformation prediction model are determined through nonlinear fitting by utilizing short-term creep test data in combination with the creep deformation performance model and creep damage parameters β_{D}. The creep deformation performance model employs the material's creep deformation characteristics and short-term creep test data to predict long-term creep deformation data.

In some embodiments, the creep deformation prediction model satisfies the following constitutive calculation formula:

$$\{ \begin{matrix}{\dot{ε}}_{c} & = {\dot{ε}}_{c , s} exp [ \frac{2 ( n + 1 )}{π \sqrt{1 + 3 / n}} {D}_{c}^{3 / 2} ] \\ {\dot{D}}_{c} & = {β}_{s} {t}^{κ} σ {\dot{ε}}_{c}\end{matrix} ,$$

Where, \dot{ε}_{c} represents the creep rate, \dot{ε}_{c,s} represents steady-state creep rate, n represents the creep stress exponent, \dot{D}_{c} represents the creep damage rate, βₛ and κ represent the second fitting parameters (also called creep damage fitting parameters), t represents creep time, and a represents the creep stress.

In some embodiments, the minimum creep stress in the short-term creep test data of S105 should be higher than the minimum creep stress in the steady-state creep rate data of S101.

S106. Determining the third fitting parameter value of the creep life prediction model based on the second fitting parameter value. The long-term creep life of the material is predicted based on the creep life prediction model, the steady-state creep rate and the creep damage parameters: specifically, creep life refers to the length of time that a material can withstand creep deformation at high temperatures.

In some embodiments, the creep life prediction model specifically satisfies the following calculation formula:

$${t}_{f} = {{β}_{A} [ \frac{σ {\dot{ε}}_{c , s}}{{β}_{D}} ]}^{{β}_{n}} ,$$

where t_{f} represents creep life, β_{A} and βₙ represent the third fitting parameters, σ represents creep stress, \dot{ε}_{c,s} represents steady-state creep rate, β_{D} represents creep damage parameters.

In some embodiments, the determination of the third fitting parameters for the creep life prediction model based on the second fitting parameter values in S106, specifically satisfies the following calculation formula:

$${β}_{A} = {[ \frac{{β}_{s}}{( κ + 1 )} ]}^{- 1 / κ + 1} ;$$

$${β}_{n} = - \frac{1}{κ + 1} .$$

In some embodiments, when performing long-term creep deformation prediction and creep life prediction, the minimum stress within the predicted stress range should be higher than the minimum creep stress in the steady-state creep rate data obtained in S101.

In some embodiments, for predicting long-term creep data based on short-term creep test data, the material is heat-resistant martensitic or austenitic steels and the temperature is between 500-700° C.

The long-term creep data prediction method based on short-term creep data provided in the embodiments employs a multi-stage stress loading method that accounts for the transition in creep damage evolution between short-term and long-term conditions, enabling accurate characterization of the accelerated creep damage effects under long-term service conditions. The method requires only short-term creep test data for predicting both long-term creep deformation and service life, eliminating dependence on actual long-term creep test results of the material. It demonstrates high extrapolation accuracy in predicting long-term creep deformation and life data at low stress levels while maintaining excellent prediction precision.

To verify the prediction accuracy of the long-term creep data prediction method based on short-term creep data provided in the embodiments, uniaxial cylindrical samples are used for validation. The material is P92 heat-resistant steel, and the uniaxial creep tests are conducted at 700° C.

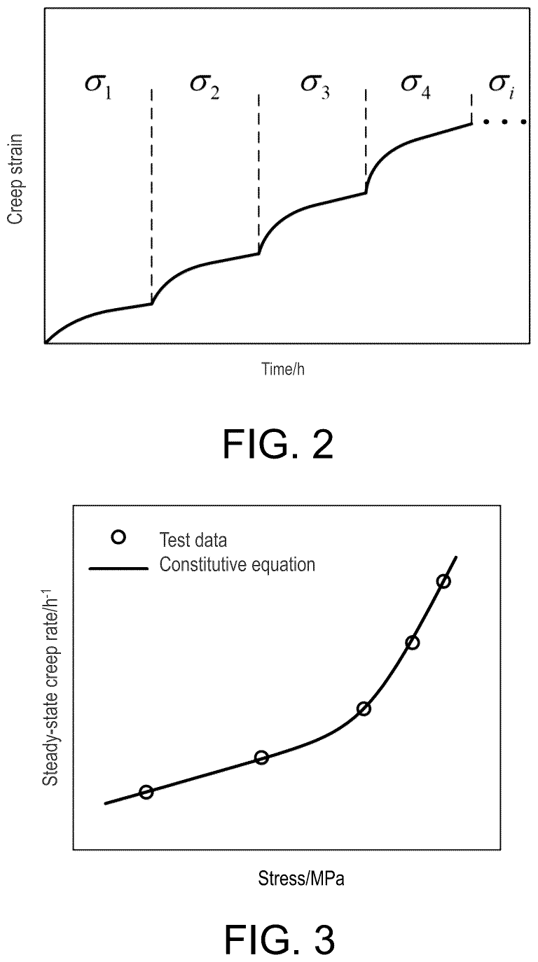

FIG. 2 is a schematic diagram of multi-stage stress loading provided in the embodiments of this application. As shown in FIG. 2, stresses are applied sequentially from high to low. Creep testing at each stress level continued until reaching the steady-state creep stage before proceeding to the next stress level, thereby obtaining steady-state creep rate data of the material under different stress levels.

FIG. 3 is a schematic diagram of parameter fitting for the creep deformation performance model provided in the embodiments. As shown in FIG. 3, nonlinear fitting is performed on the steady-state creep rate data under different stress levels to determine the first fitting parameter values of the creep deformation performance model. The first fitting parameter values include the creep stress exponent n₁ and n₂ and the creep stress coefficient A₁ and A₂.

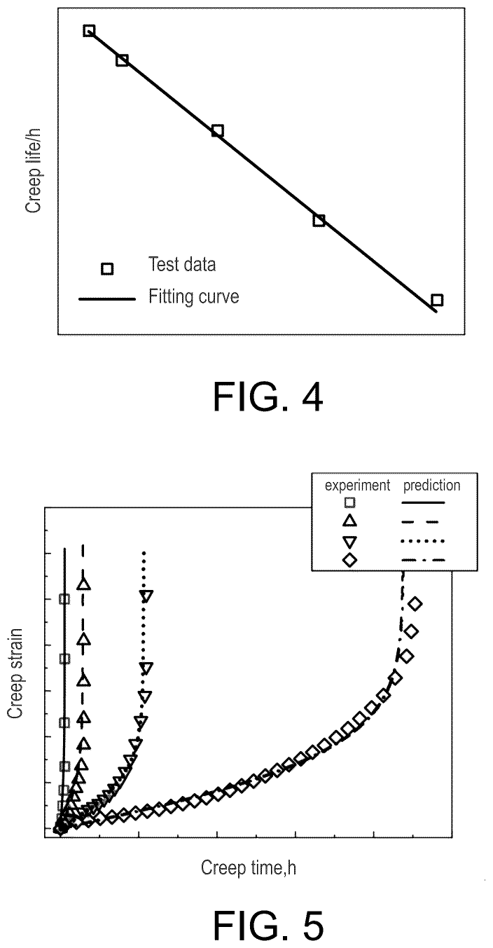

FIG. 4 is a schematic diagram of parameter fitting for the creep deformation prediction model provided in the embodiments. As shown in FIG. 4, short-term creep test data is utilized, combined with the creep deformation performance model and creep damage parameters β_{D}, to fit and determine the second fitting parameter values βₛ and κ of the creep deformation prediction model.

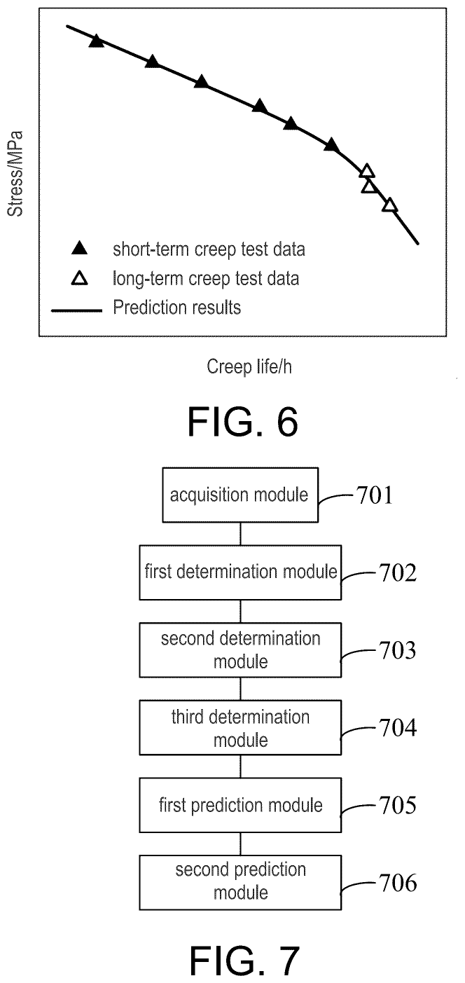

FIG. 5 is a schematic diagram of long-term creep deformation prediction results provided in the embodiments. FIG. 6 is a schematic diagram of long-term creep life prediction results provided in the embodiments. The prediction results for long-term creep deformation and life under 700° C. conditions are shown in FIG. 5 and FIG. 6, demonstrating good performance for creep deformation and life prediction under long-term creep conditions.

FIG. 7 is a schematic structural diagram of the long-term creep data prediction device based on short-term creep data provided by the embodiments of the present disclosure. As shown in FIG. 7, the device at least comprises:
acquisition module 701, configured to obtain steady-state creep rate data under different stress levels through a multi-stage stress step-loading method based on short-term creep data obtained from short-term creep tests;
first determination module 702, configured to determine the first fitting parameter values of the creep deformation performance model through nonlinear fitting; the creep deformation performance model characterizes the evolution law of the material's steady-state creep rate with stress;
second determination module 703, configured to determine the creep stress exponent n under different stress levels based on the steady-state creep rate data and creep stress;
third determination module 704, configured to determine the creep damage parameter β_{D} under different stress levels based on the creep stress exponent n and the creep damage parameter model; the creep damage parameter model characterizes the evolution law of the material's creep damage parameter β_{D} with the creep stress exponent n;
first prediction module 705, configured to determine the second fitting parameter values of the creep deformation prediction model through nonlinear fitting based on the short-term creep test data, the creep deformation performance model, and the creep damage parameter, and to predict the long-term creep deformation of the material based on the creep deformation prediction model;
second prediction module 706, configured to determine the third fitting parameter values of the creep life prediction model based on the second fitting parameter values, and to predict the long-term creep life of the material based on the creep life prediction model, steady-state creep rate, and creep damage parameter β_{D}.

In some embodiments, the multi-stage stress step-loading method comprises:
stresses are applied sequentially from low to high. Creep testing at each stress level continued until reaching the steady-state creep stage before proceeding to the next stress level, thereby obtaining steady-state creep rate data of the material under different stress levels.

In some embodiments, the step-loading stress level is greater than 10% σ_{y}, where σ_{y} is the material's yield strength.

In some embodiments, the creep deformation performance model satisfies the following calculation formula:

$${\dot{ε}}_{c , s} = {A}_{1} {σ}^{{n}_{1}} + {A}_{2} {σ}^{{n}_{2}} ,$$

where, \dot{ε}_{c,s} is the steady-state creep rate, n₁ and n₂ are the fitted creep stress exponents, A₁ and A₂ are the fitted creep stress coefficients, σ is the creep stress.

In some embodiments, the creep stress exponent n at different stress levels is determined by the following calculation formula:

$$n = \frac{d 1 g ( {\dot{ε}}_{c , s} )}{d 1 g ( σ )} ,$$

where, \dot{ε}_{c,s} represents steady-state creep rate, σ represents the creep stress.

In some embodiments, the creep damage parameter model satisfies the following calculation formula:

$${β}_{D} = 0.3034 exp ( - 0.1023 n ) + 0.5031 exp ( - 0.3519 n ) + 0.1634 exp ( - 0.01213 n ) ,$$

where, β_{D} represents creep damage parameter, n represents creep stress exponent.

In some embodiments, the creep deformation prediction model satisfies the following calculation formula:

$$\{ \begin{matrix}{\dot{ε}}_{c} & = {\dot{ε}}_{c , s} exp [ \frac{2 ( n + 1 )}{π \sqrt{1 + 3 / n}} {D}_{c}^{3 / 2} ] \\ {\dot{D}}_{c} & = {β}_{s} {t}^{κ} σ {\dot{ε}}_{c}\end{matrix} ,$$

where \dot{ε}_{c} represents creep rate, \dot{ε}_{c,s} represents steady-state creep rate, n represents creep stress exponent, \dot{D}_{c} represents creep damage rate, βₛ and κ represent the second fitting parameter values, t represents creep time, σ represents creep stress.

In some embodiments, the creep prediction model satisfies the following calculation formula:

$${t}_{f} = {{β}_{A} [ \frac{σ {\dot{ε}}_{c , s}}{{β}_{D}} ]}^{{β}_{n}} ,$$

where t_{f} represents creep life, β_{A} and βₙ represent the third fitting parameter values, σ represents creep stress, \dot{ε}_{c,s} represents steady-state creep rate, β_{D} represents creep damage parameter.

In some embodiments, the third fitting parameter values of the creep life prediction model are determined based on the second fitting parameter values according to the following calculation formula:

$${β}_{A} = {[ \frac{{β}_{s}}{( κ + 1 )} ]}^{- 1 / κ + 1} ;$$

$${β}_{n} = - \frac{1}{κ + 1} .$$

It should be understood that the detailed functional implementations of the aforementioned units/modules can be found in the descriptions provided in the preceding method embodiments, and thus will not be reiterated here.

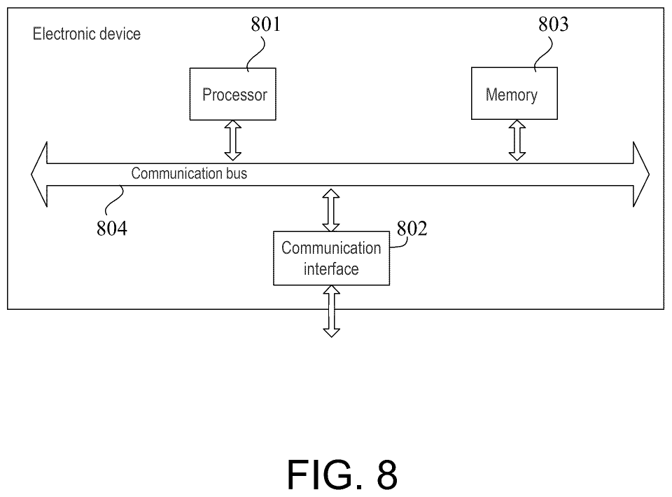

Based on the method in the above embodiment, an embodiment of the disclosure provides an electronic device, as shown in FIG. 8. The electronic device may include a processor, a communication interface, a memory, and a communication bus. The processor, the communication interface, and the memory communicate with each other through the communication bus. The processor may call logic instructions in the memory to execute the method in the above embodiment.

In addition, the logic instructions in the above memory 803 may be implemented in a form of a software functional unit and may be stored in a computer-readable storage medium when sold or used as an independent product. Based on such an understanding, the technical solution in the disclosure, a part that contributes to the related art, or a part of the technical solution may be embodied in a form of a software product. The computer software product is stored in a storage medium and includes several instructions for enabling a computer device (which may be a personal computer, a server, a network device, etc.) to execute all or a part of the steps of the method described in each of the embodiments of the disclosure.

Based on the method in the above embodiment, an embodiment of the disclosure provides a computer-readable storage medium, and the computer-readable storage medium stores a computer program. When the computer program runs on the processor, the processor executes the method in the above embodiment.

Based on the method in the above embodiment, an embodiment of the disclosure provides a computer program product. When the computer program product runs on the processor, the processor executes the method in the above embodiment.

It may be understood that the processor in the embodiment of the disclosure may be a central processing unit (CPU), or may further be other general-purpose processors, digital signal processors (DSP), application specific integrated circuits (ASIC), field programmable gate arrays (FPGA), or other programmable logic devices, transistor logic devices, hardware components or any combination thereof. The general-purpose processor may be a microprocessor or any conventional processor.

The steps of the method in the embodiment of the disclosure may be implemented by hardware, or by the processor executing software instructions. The software instructions may be composed of corresponding software modules. The software modules may be stored in a random-access memory (RAM), flash memory, read-only memory (ROM), programmable ROM (PROM), erasable PROM (EPROM), electrically EPROM (EEPROM), register, hard disk, mobile hard disk, CD-ROM, or any other form of storage medium known in the art. An exemplary storage medium is coupled to the processor, so that the processor may read information from, and write information to, the storage medium. Of course, the storage medium may also be an integral part of the processor. The processor and the storage medium may reside in the ASIC.

In the above embodiments, all or a part of the embodiments may be implemented by software, hardware, firmware, or any combination thereof. When implemented using the software, all or a part of the embodiments may be implemented in a form of the computer program product. The computer program product includes one or more computer instructions. When the computer program instructions are loaded and executed on a computer, all or a part of processes or functions described in the embodiment of the disclosure are generated. The computer may be a general-purpose computer, a special-purpose computer, a computer network, or other programmable device. The computer instructions may be stored in the computer-readable storage medium or transmitted through the computer-readable storage medium. The computer instructions may be transmitted from one website, computer, server, or data center to another website, computer, server, or data center in wired (e.g., a coaxial cable, an optical fiber, a digital subscriber line (DSL)) or wireless (e.g., infrared, wireless, microwave, etc.) manner. The computer-readable storage medium may be any available medium that may be accessed by the computer or a data storage device such as the server or the data center that includes one or more available media. The available medium may be a magnetic medium (e.g., a floppy disk, a hard disk, a magnetic tape), an optical medium (e.g., a DVD), or a semiconductor medium (e.g., a solid state disk (SSD)).

It should be understood that various reference numerals involved in the embodiments of the disclosure are only used for the convenience of description and are not used to limit the scope of the embodiments of the disclosure.

It will be easily understood by those skilled in the art that the above description is only a preferred embodiment of the disclosure and is not intended to limit the disclosure. Any modifications, equivalent substitutions, and improvements made within the spirit and principles of the disclosure shall be included in the scope of the disclosure.

What is claimed is:

1. A method for predicting long-term creep data based on short-term creep data, comprising:
conducting short-term creep tests using a step-loading method under multi-stage stress to obtain steady-state creep rate data of material at different stress levels;
determining first fitting parameter values of a creep deformation performance model through nonlinear fitting, wherein the creep deformation performance model is used to characterize an evolution law of the material's steady-state creep rate with stress;
determining a creep stress exponent n at different stress levels based on the steady-state creep rate data and creep stress;
determining a creep damage parameter β_{D} at different stress levels based on the creep stress exponent n and a creep damage parameter model, wherein the creep damage parameter model characterizes an evolution law of the material's creep damage parameter β_{D} with the creep stress exponent n;
determining second fitting parameter values of a creep deformation prediction model through nonlinear fitting based on short-term creep test data, the creep deformation performance model, and the creep damage parameter β_{D}; predicting long-term creep deformation of the material using the creep deformation prediction model;
determining third fitting parameter values of a creep life prediction model based on the second fitting parameter values; predicting long-term creep life of the material based on the creep life prediction model, steady-state creep rate and the creep damage parameter β_{D}.

2. The method for predicting the long-term creep data according to claim 1, wherein the step-loading method for the multi-stage stress comprises:
stresses are applied sequentially from small to large magnitudes, creep testing at each of the stress levels continued until reaching a steady-state creep stage before proceeding to a next stress level, thereby obtaining the steady-state creep rate data of the material under different the stress levels.

3. The method for predicting the long-term creep data according to claim 2, wherein a step-loading stress level is greater than 10% σ_{y}, where σ_{y} is the material's yield strength.

4. The method for predicting the long-term creep data according to claim 1, wherein the creep deformation performance model satisfies the following calculation formula:
$${\dot{ε}}_{c , s} = {A}_{1} {σ}^{{n}_{1}} + {A}_{2} {σ}^{{n}_{2}} ,$$
Where, \dot{ε}_{c,s} represents the steady-state creep rate, n₁ and n₂ represent fitted creep stress exponents, A₁ and A₂ represent fitted creep stress coefficients, σ represents the creep stress.

5. The method for predicting the long-term creep data according to claim 1, wherein the creep stress exponent n is determined by the following calculation formula:
$$n = \frac{d 1 g ( {\dot{ε}}_{c , s} )}{d 1 g ( σ )} ,$$
wherein, \dot{ε}_{c,s} represents the steady-state creep rate, σ represents the creep stress.

6. The method for predicting the long-term creep data according to claim 5, wherein the creep damage parameter model satisfies the following calculation formula:
$${β}_{D} = 0.3034 exp ( - 0.1023 n ) + 0.5031 exp ( - 0.3519 n ) + 0.1634 exp ( - 0.01213 n ) ,$$
where β_{D} represents the creep damage parameter, n represents the creep stress exponent.

7. The method for predicting the long-term creep data according to claim 1, wherein the creep deformation prediction model satisfies the following calculation formula:
$$\{ \begin{matrix}{\dot{ε}}_{c} & = {\dot{ε}}_{c , s} exp [ \frac{2 ( n + 1 )}{π \sqrt{1 + 3 / n}} {D}_{c}^{3 / 2} ] \\ {\dot{D}}_{c} & = {β}_{s} {t}^{κ} σ {\dot{ε}}_{c}\end{matrix} ,$$
Where, \dot{ε}_{c} represents the creep rate, \dot{ε}_{c,s} represents the steady-state creep rate, n represents the creep stress exponent, \dot{D}_{c} represents the creep damage rate, βₛ and κ are the second fitting parameters, t represents creep time, and a represents the creep stress.

8. The method for predicting the long-term creep data according to claim 7, wherein the creep life prediction model satisfies the following calculation formula:
$${t}_{f} = {{β}_{A} [ \frac{σ {\dot{ε}}_{c , s}}{{β}_{D}} ]}^{{β}_{n}} ,$$
Where t_{f} represents creep life, β_{A} and βₙ represent the third fitting parameters, σ represents the creep stress, \dot{ε}_{c,s} represents the steady-state creep rate, β_{D} represents creep damage parameters.

9. The method for predicting the long-term creep data according to claim 8, wherein the determination of the third fitting parameters for the creep life prediction model based on the second fitting parameter satisfies the following calculation formula:
$${β}_{A} = {[ \frac{{β}_{s}}{( κ + 1 )} ]}^{- 1 / κ + 1} ;$$
$${β}_{n} = - \frac{1}{κ + 1} .$$
Wherein, β_{A} and βₙ represent the third fitting parameters.

10. A device for predicting long-term creep data based on short-term creep data, comprising:
an acquisition module, configured to conduct short-term creep tests using a step-loading method under multi-stage stress to obtain steady-state creep rate data of material at different stress levels;
a first determination module, configured to determine first fitting parameter values of a creep deformation performance model through nonlinear fitting; the creep deformation performance model being used to characterize an evolution law of a material's steady-state creep rate with stress;
a second determination module, configured to determine a creep stress exponent n at different stress levels based on steady-state creep rate data and creep stress;
a third determination module, configured to determine a creep damage parameter β_{D} at different stress levels based on the creep stress exponent n and a creep damage parameter model; the creep damage parameter model being used to characterize an evolution law of a material's creep damage parameter β_{D} with the creep stress exponent n;
a first prediction module, configured to determine second fitting parameter values of a creep deformation prediction model through nonlinear fitting based on short-term creep test data, the creep deformation performance model and the creep damage parameter, and to predict long-term creep deformation of a material using the creep deformation prediction model;
a second prediction module, configured to determine third fitting parameter values of a creep life prediction model based on the second fitting parameter values, and to predict long-term creep life of a material using the creep life prediction model, steady-state creep rate and the creep damage parameter β_{D}.
